(19) United States
(12) Patent Application Publication
(10) Pub. No.: US 2025/0197139 A1
(43) Pub. Date: Jun. 19, 2025

(54) IDENTIFICATION OF MOVEMENT DEVICES OF A LINEAR ELECTRIC DRIVE CONVEYOR

(71) Applicant: KRONES AG, Neutraubling (DE)

(72) Inventors: Stefan ELSPERGER, Soechtenau (DE); Thomas KIENDL, Maxhuette-Haidhof (DE)

(21) Appl. No.: 18/843,050

(22) PCT Filed: Mar. 9, 2023
(86) PCT No.: PCT/EP2023/056022

§ 371 Date: Aug. 30, 2024

(30) Foreign Application Priority Data
Mar. 16, 2022 (DE) DE102022106160.4

(51) Int. Cl. B65G 54/02; B65G 43/00

(52) U.S. Cl. CPC B65G 54/02; B65G 43/00; B65G 2203/0283

(57) ABSTRACT

The invention relates, inter alia, to a method for operating, preferably initializing, a linear electric drive conveyor having a plurality of movement devices. The method comprises lining up the plurality of movement devices such that the plurality of movement devices that have been lined up touch one another. Positions of the plurality of movement devices that have been lined up are determined. At least one first movement device and/or at least one second movement device is/are identified in the plurality of movement devices that have been lined up on the basis of the determined positions. The method advantageously makes it possible to dispense with external sensors for the purpose of identification. The method can also be used particularly flexibly in each section of the linear electric drive conveyor.

### TECHNICAL FIELD

The invention relates to a method for operating a linear electric drive conveyor with multiple movement devices. The invention also relates to an industrial plant, preferably a container treatment plant, with a linear electric drive conveyor. The invention also relates to a linear electric drive conveyor.

### TECHNICAL BACKGROUND

A current development trend in the transport of containers, such as bottles or cans, in systems and machines for the production, filling and packaging of beverages and liquid foodstuffs is linear motor technology, e.g., in the form of long-stator linear drive systems or short-stator linear drive systems. The movement devices, also known as “shuttles” or “movers”, can each move one or more containers. A major advantage of linear motor technology is that the movement devices can be controlled and moved individually or separately and independently of one another.

Certain applications may require that the movement devices of a conveyor are constructed differently or that a conveyor has type A and type B movement devices. This may be necessary, e.g., in the concept of holder and counterholder, which can hold or clamp a transport item between them. For the operation of this type of conveyor, it is necessary to identify the type of movement devices. The movement device identified in this way can then be operated or controlled according to its type, e.g., as a holder or as a counterholder. Complex external sensors may be required for identification.

For example, WO 2013/189 656 A1 discloses a feeding device for feeding products or product stacks to a packaging process of a packaging machine. The feeding device has a guide unit designed as a closed loop, on which a plurality of conveyor elements assembled at least along at least one working section of the guide unit are arranged to be driven independently of one another in a speed- and/or position-controlled manner. At least one conveying element has a holder and at least one conveying element following against a conveying direction has a counterholder.

The invention is based on the task of creating an improved technique for identifying a respective type of movement device of a linear electric drive conveyor.

### SUMMARY OF THE INVENTION

The object is achieved by the features of the independent claims. Advantageous developments are specified in the dependent claims and the description.

One aspect of the present disclosure relates to a method for operating, preferably initializing, a linear electric drive conveyor (e.g., for transporting transport goods, preferably containers) having a plurality of movement devices which are electromagnetically and independently movable. The plurality of movement devices comprise at least one first movement device having a first external geometry and at least one second movement device having a second external geometry that is different from the first external geometry. The method comprises lining up the plurality of movement devices such that the plurality of movement devices that have been lined up touch one another. The method has a determination of positions of the lined up multiple movement devices (e.g., by means of a control unit of the linear electric drive conveyor and/or a sensor system of the linear electric drive conveyor). The method further comprises identifying the at least one first movement device and/or the at least one second movement device in the lined up plurality of movement devices based on the determined positions (e.g., by means of a control unit of the linear electric drive conveyor).

Advantageously, the method can enable the identification of different types of movement devices without the need for external sensors. The method is therefore particularly cost-effective and reliable. For identification, the method simply uses the differences in positioning resulting from the different external geometries of the different types of movement devices when the movement devices are lined up. Due to the different external geometry, the different types of movement devices can move together to different distances until they touch one another, which is reflected in the positions determined. Stringing can also take place in any section of the linear electric drive conveyor, making the method particularly flexible.

For example, it may be possible that the linear electric drive conveyor has a plurality of movement devices and that the steps of lining up, determining positions and identifying take place in several sections of the linear electric drive conveyor for different groups of several movement devices, preferably simultaneously.

It is also possible that the linear electric drive conveyor has further movement devices in addition to the multiple movement devices. The method can preferably also be carried out for these other movement devices. Alternatively, the method may not be performed for these further movement devices and instead, e.g., based on the step of identifying the method, it may be derived which of the further movement devices are first movement devices and which of the further movement devices are second movement devices. Such an approach is possible, e.g., if the first movement devices and the second movement devices are arranged alternately along the entire linear electric drive conveyor.

Preferably, lining up can take place without holding the transported goods.

Preferably, the stringing can be controlled by a control unit of the linear electric drive conveyor. Alternatively or additionally, the lineup can be carried out manually, e.g., when the linear electric drive conveyor is commissioned for the first time.

In an exemplary embodiment, the identifying is further based on at least one predetermined (e.g., stored or inputted) geometry information relating to the first external geometry and/or the second external geometry and/or a difference between the first external geometry and the second external geometry.

In a further exemplary embodiment, the method further comprises determining at least one distance between the determined positions, and the identifying is further based on the determined at least one distance.

In a further exemplary embodiment, the at least one first movement device and the at least one second movement device differ from one another in their outer contours directed in a movement direction (e.g., forward movement direction, backward movement direction, sideways movement direction). Preferably, the multiple movement devices can be lined up in the direction of movement.

In one embodiment, the at least one first movement device has a first tool. In addition, the at least one second movement device may have no tool. Alternatively, the at least one second movement device may have a second tool, wherein the first tool and the second tool are differently oriented, differently formed and/or differently arranged.

Preferably, the first tool can influence the first external geometry and the second tool can influence the second external geometry in such a way that the first external geometry and the second external geometry differ from one another.

In a further embodiment, the at least one first movement device has a holder, preferably a container holder. Preferably, the at least one second movement device can have a counterholder, preferably a container counterholder.

Preferably, the holder can influence the first external geometry and the counterholder can influence the second external geometry in such a way that the first external geometry and the second external geometry differ from one another.

In a further embodiment, the at least one first movement device has a spacer. In addition, the at least one second movement device may have no spacer or a further spacer, wherein the spacer and the further spacer are differently oriented, differently dimensioned and/or differently arranged. The method can therefore also be used advantageously with movement devices in which the tools are designed in such a way that they do not influence the positions when the movement devices are lined up.

Preferably, the at least one first movement device and the at least one second movement device can touch one another when lining up via the spacer.

Preferably, the spacer can influence the first external geometry in such a way that the first external geometry and the second external geometry differ from one another.

For example, the spacer can be arranged on an outer side of the at least one first movement device, wherein the outer side is directed in a forward travel direction of the at least one first movement device or against the forward travel direction.

In a further embodiment, the positions are determined by means of a, preferably internal, sensor system, preferably having several position sensors, of the linear electric drive conveyor. Alternatively or additionally, the positions can be determined by detecting electromagnetic induction in at least one coil of the linear electric drive conveyor caused by the multiple movement devices.

In one embodiment, the plurality of movement devices can be lined up at a speed that is less than a normal operating speed of the plurality of movement devices, preferably ≤0.5 m/s. Alternatively or additionally, the multiple movement devices can be lined up with a force control that preferably limits a maximum thrust force with which the multiple movement devices push against one another. Alternatively or additionally, the multiple movement devices can be lined up by means of an adapted controller parameterization so that, in the event of contact, a maximum force is within a predetermined range and preferably an increase in a motor temperature is reduced. Alternatively or additionally, the multiple movement devices can be braked immediately before they touch one another. The method can therefore be carried out particularly gently and damage to the multiple movement devices can be prevented.

In one exemplary embodiment, identification takes place without external sensors and/or is purely software-based.

In a further exemplary embodiment, a first movement device and a second movement device are each designed for jointly transporting a transport item, preferably a container, which is clamped or held between them.

In a further exemplary embodiment, the at least one first movement device has a plurality of first movement devices, and the at least one second movement device has a plurality of second movement devices. Preferably, the plurality of first movement devices and the plurality of second movement devices can be arranged alternately one after the other.

In a further exemplary embodiment, the method further comprises operating the linear electric drive conveyor in a normal operating mode, preferably for transporting transported goods, in response to the identifying.

In one embodiment, the method further has an output of an error message (e.g., by means of a user interface) if the identified at least one first movement device and/or the identified at least one second movement device is/are arranged in an order that deviates from a desired order.

In another embodiment, the linear electric drive conveyor is a long-stator linear drive conveyor, a short-stator linear drive conveyor or a planar linear drive conveyor.

Another aspect of the present disclosure relates to a linear electric drive conveyor or an industrial plant, preferably a container treatment plant, with a linear electric drive conveyor. The linear electric drive conveyor has a plurality of movement devices which can be moved electromagnetically and independently of one another, wherein the plurality of movement devices have at least one first movement device with a first external geometry and at least one second movement device with a second external geometry which is different from the first external geometry. The linear electric drive conveyor further has a control unit configured to perform a method according to any one of the preceding claims.

Preferably, the container treatment system can be designed for the production, cleaning, coating, testing, filling, closing, labeling, printing and/or packaging of containers for liquid media, preferably beverages or liquid foodstuffs.

For example, the containers can be configured as bottles, cans, canisters, cartons, vials, etc.

Preferably, the term “control unit” can refer to an electronic system (e.g., designed as a driver circuit or with microprocessor(s) and data memory) which, depending on the design, can perform control tasks and/or regulation tasks and/or processing tasks. Although the term “control” is used herein, this can also comprise or be understood as “regulate” or “feedback-control” and/or “process.”

The preferred embodiments and features of the invention described above can be combined with one another as desired.

### BRIEF DESCRIPTION OF THE DRAWINGS

Further details and advantages of the invention are described below with reference to the accompanying drawings. In the figures:

FIG. 1 a schematic side view of a section of a linear electric drive conveyor in a normal operating mode;

FIG. 2 a schematic side view of a section of the linear electric drive conveyor of FIG. 1 in an initialization mode according to an exemplary embodiment of the present disclosure;

FIG. 3 a schematic side view of a section of a linear electric drive conveyor in a normal operating mode; and

FIG. 4 a schematic side view of a section of the linear electric drive conveyor of FIG. 3 in an initialization mode according to an exemplary embodiment of the present disclosure;

The embodiments shown in the drawings correspond at least in part, so that similar or identical parts are provided with the same reference signs and reference is also made to the description of other embodiments or figures for the explanation thereof to avoid repetition.

### DETAILED DESCRIPTION OF EMBODIMENTS

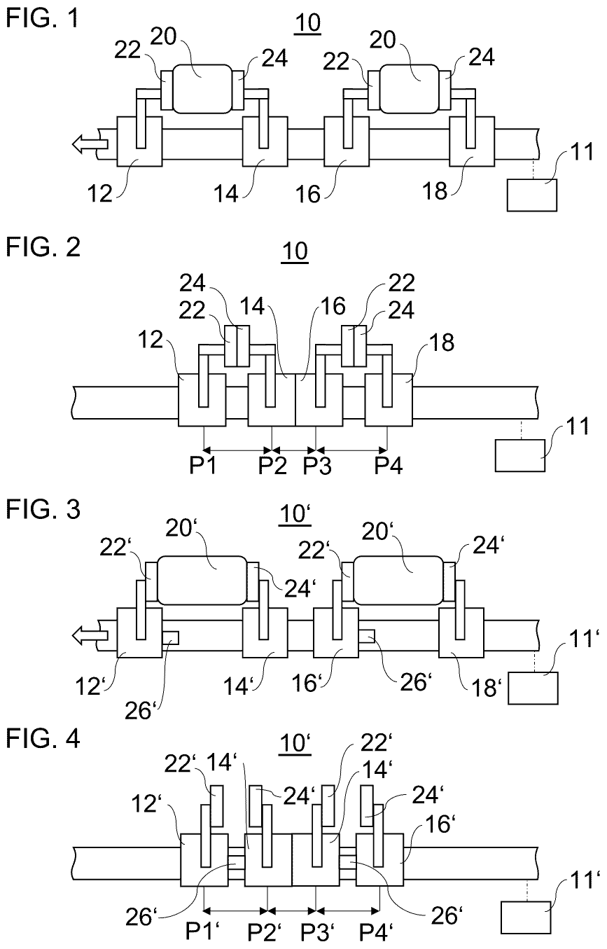

FIG. 1 shows a linear electric drive conveyor 10 with several movement devices 12, 14, 16, 18. For example, the conveyor 10 may be comprised in an industrial plant for transporting goods 20. The transport goods 20 may each comprise one or more subject matters, preferably containers. Preferably, the conveyor 10 can be designed to transport goods 20 in the form of containers. Particularly preferably, the conveyor 10 can be comprised in a container treatment system for treating containers, e.g., to transport the containers between container treatment devices of the container treatment system.

The movement devices 12-18 can be moved electromagnetically. The movement devices 12-18 can be moved independently of one another. It is possible that, despite the independent movability, there is a mechanical coupling between individual movement devices 12-18 (not shown in FIG. 1). The multiple movement devices 12-18 can be individually controlled by a control unit 11 of the conveyor 10, e.g., directly if they themselves have electromagnets, or indirectly if they have permanent magnets.

Preferably, the conveyor 10 can be a long-stator linear drive conveyor.

The long-stator linear drive conveyor may have the plurality of movement devices 12-18, which are guided along a preferably circumferential guide track, e.g., by means of rollers or sliding shoes. The movement devices 12-18 can be driven by means of magnetic interaction between permanent magnets and electromagnets. The long-stator linear drive conveyor may comprise a stationary long-stator with electromagnets for effecting movement of the movement devices 12-18 equipped with permanent magnets.

However, it is also possible for the conveyor 10 to be a short-stator linear drive conveyor or a planar linear drive conveyor, e.g.

The short-stator linear drive conveyor may have the plurality of movement devices 12-18, which are guided along a preferably circumferential guide track, e.g., by means of rollers or sliding shoes. The movement devices 12-18 can be driven by means of magnetic interaction between permanent magnets and electromagnets. In the short-stator linear drive conveyor, the movement devices 12-18 can each have a short-stator formed by electromagnets, which can enter into magnetic interaction with stationary permanent magnets in order to move the movement devices 12-18.

The planar linear drive conveyor or the planar motor linear drive conveyor may have the plurality of movement devices 12-18, which can be moved independently of each other with at least two degrees of freedom (x-direction and y-direction) over a preferably planar drive surface by means of magnetic interaction with the drive surface. It is also possible that a lifting movement (z-direction) and/or a tilting movement of the movement devices 12-18 relative to the drive surface can also be controlled by means of the magnetic interaction. Preferably, the drive surface can be oriented horizontally or vertically.

The movement devices 12-18 have first movement devices 12, 16 and second movement devices 14, 18. It is understood that the conveyor 10 may have more than two first movement devices 12, 16 and/or more than two second movement devices 14, 18. It is possible that the conveyor 10 has only a first movement device 12 or 16 and/or only a second movement device 14 or 18.

Preferably, the first movement devices 12, 16 and the second movement devices 14, 18 are arranged alternately one after the other. However, it is also possible that in other applications, e.g., several first movement devices directly follow one another and/or several second movement devices directly follow one another.

The first movement device 12 and the second movement device 14 can jointly transport a transport item 20. The transport item 20 can be clamped or held between the first movement device 12 and the second movement device 14. The first movement device 16 and the second movement device 18 can also transport a further transport item 20 together. The further transport item 20 can be clamped or held between the first movement device 16 and the second movement device 18. In general, a first movement device 12, 16 and a second movement device 14, 18 can each jointly transport a transport item 20.

The first movement devices 12, 16 each have an identical first external geometry. The second movement devices 14, 18 each have an identical second external geometry. The first external geometry differs from the second external geometry.

The differences between the first external geometry and the second external geometry are caused, e.g., by tools 22, 24. The first movement devices 12, 16 may each have a first tool 22. The second movement devices 14, 18 may each have a second tool 24.

Although the tools 22, 24 may be of the same design in the exemplary embodiment, the tools 22, 24 are oriented in opposite directions. Additionally or alternatively, it is also possible that the first tools 22 and the second tools 24 differ in design from one another. Alternatively, it is also possible, e.g., that only the first movement devices 12, 16 each have the first tool 22 and the second movement devices 14, 18 have no tool.

The first tools 22 can project or protrude beyond a base or a base body of the respective first movement device 12, 16, e.g., against the forward direction of travel. The second tools 24 can be discharged via or project beyond a base or a base body of the respective second movement device 14, 18, e.g., in the forward direction of travel.

The first tools 22 can each serve as a holder for a transport item 20. The second tools 24 can each serve as a counterholder for a transport item 20. For example, if the transport item 20 is a container, the first tools 22 can each be container holders and the second tools 24 can each be container counterholders.

A first tool 22 and a second tool 24 can cooperate with each other to hold a transport item 20. For example, the first tool 22 of the first movement device 12 and the second tool 24 of the second movement device 14 may cooperate to hold a transport item 20 between them, e.g., during transportation.

In the exemplary embodiment, when the conveyor 10 is activated or switched on, the control unit 11 of the conveyor 10 does not know which of the movement devices 12-18 belong to the first movement devices and which of the movement devices 12-18 belong to the second movement devices. However, this knowledge is required for normal operation of the conveyor 10, since a transport item 20 can be transported jointly by the first movement device 12 and the second movement device 14, but not jointly by the second movement device 14 and the first movement device 16. It is therefore necessary to identify the movement devices 12-18 according to their type (first or second movement device?).

For example, in an initialization mode, in which preferably no transport items 20 are yet being transported, the conveyor 10 can be controlled, preferably by means of the control unit 11, in such a way that the multiple movement devices 12-18 lineup, as shown in FIG. 2 as an example. The lined up movement devices 12-18 touch each other, i.e., the directly adjacent movement devices 12-18 touch one another.

For example, the first movement device 12 and the second movement device 18 may touch one another at their tools 22, 24. The second movement device 14 and the first movement device 16 can touch one another at their bases or base bodies. The first movement device 16 and the second movement device 18 can in turn touch one another at their tools 22, 24.

The lining up can, e.g., take place in such a way that one of the movement devices 12-18, e.g., the movement device 12, is stopped or not moved at all. The other movement devices 14-18 can then be lined up one after the other behind the stopped movement device 12. In principle, lining up can take place in the forward travel direction or against the forward travel direction of the movement devices 12-18. It is also possible for the lining up to take place partly in the forward travel direction and partly against the forward travel direction of the movement devices 12-18, e.g., to enable particularly short paths for the movement devices 12-18 to lineup.

Preferably, the movement devices 12-18 are moved at a comparatively low speed during stringing. The speed is preferably less than a normal operating speed of the movement devices 12-18. For example, this speed can be ≤0.5 m/s when stringing. It is also possible that the movement devices 12-18 are braked immediately before they come into contact.

Particularly preferably, the control unit 11 of the conveyor 10 performs a force control or an adapted controller parameterization during stringing, which limits a maximum force or pushing force with which the multiple movement devices 12-18 can push against each other on contact. Preferably, a limit value for the maximum force or pushing force can be specified, e.g., by means of a user interface of the conveyor 10.

After the movement devices 12-18 have been lined up, the positions P1-P4 of the movement devices 12-18 are determined. For example, this can be done by means of a, preferably internal, sensor system of the conveyor 10. The conveyor 10 can, e.g., have several position sensors arranged along a static part, such as the guide track, the long-stator or the drive surface, of the conveyor 10. It is also possible, e.g., that the sensor system can determine the positions P1-P4 by detecting electromagnetic induction in at least one stationary coil of the conveyor 10 caused by the multiple movement devices 12-18.

Due to the different external geometries, the movement devices 12-18 can move together at different densities when they are lined up. For example, the second movement device 14 and the first movement device 16 may move very close together until the bases or base bodies of the movement devices 14, 16 touch one another, as the tools 22, 24 do not already touch one another beforehand. On the other hand, the first movement device 12 and the second movement device 14 cannot move as close together because the tools 22, 24 touch one another before the bases or base bodies of the movement devices 12, 14 can touch one another. The same applies to the first movement device 16 and the second movement device 18.

Based on the determined positions P1-P4, the movement devices 12-18 can be identified by the control unit 11 of the conveyor 10. Preferably no external sensors are required. Instead, the control unit 11 can preferably identify the movement devices 12-18 purely on the basis of software. Specifically, the control unit 11 may identify the movement devices 12, 16 as first movement devices. The control unit 11 can identify the movement devices 14, 18 as second movement devices.

Preferably, the control unit 11 can access further information to identify the movement devices 12-18. Particularly preferably, geometry information relating to the first movement devices 12, 16 and the second movement devices 14, 18 is stored in the control unit 11. For example, the geometry information may relate to dimensions of the tools 22, 24, dimensions of the bases or main bodies of the movement devices 12-18, and/or overall dimensions of the individual movement devices 12-18. Preferably, the dimensions are measured with respect to a longitudinal axis or the forward direction of travel of the respective movement device 12-18.

It is possible for the control unit 11 to determine distances between positions P1-P4. The control unit 11 can then, e.g., analyze or evaluate the determined distances and the geometry information in order to identify the movement devices 12-18. Due to the different external geometries of the movement devices 12-18, non-equidistant distances between the positions P1-P4 may result in particular.

Based on the identification of the movement devices 12-18, the control unit 11 can operate the conveyor 10 in a normal operating mode, e.g., to transport the transported goods 20. In this case, the control unit 11 can control the conveyor 10, e.g., in such a way that for transporting a transport item 20, one of the first movement devices 12, 16 holds the transport item 20 from the front and one of the second movement devices 14, 18 holds the transport item 20 from the rear.

Alternatively, the control unit 11 can preferably output an error message by means of a user interface, e.g., a display or a light, if an order of assembly of the identified movement devices 12-18 deviates from a desired order. This can be the case, e.g., if it is detected that two first movement devices or two second movement devices are mistakenly in direct succession. Such problems may arise, e.g., due to an incorrect assembly of the movement devices 12-18 when inserting the movement devices into or onto the conveyor 10.

FIGS. 3 and 4 show a modified exemplary embodiment.

Although the tools 22′ and 24′ are designed differently or are oriented differently, they do not protrude beyond the bases or base bodies of the movement devices 12′-18′. In order to nevertheless create a distinguishable external geometry for the identification of the movement devices 12′-18′, the first movement devices 12′, 16′ each have a spacer 26′ as an example.

The spacer 26′ can, e.g., be arranged in each case on an outer side of the first movement devices 12′, 16′ facing in the opposite direction to the forward travel direction. Alternatively, the spacer 26′ could, e.g., be arranged in each case on an outer side of the first movement devices 12′, 16′ facing in the forward travel direction.

When lining up, the second movement device 14′ can touch the first movement device 12′ via the spacer 26′ of the first movement device 12′. Similarly, the second movement device 18′ can touch the first movement device 16′ via the spacer 26′ of the first movement device 16′. On the other hand, the second movement device 14′ and the first movement device 16′ can touch each other at their bases or base bodies. When lining up, therefore, there are again non-equidistant distances between the positions P1′-P4′, so that the movement devices 12′-18′ can be identified on the basis of the positions P1′-P4.

Preferably, the second movement devices 14′, 18′ have no spacers or at least no spacers corresponding to the spacers 26′. It is possible that the second movement devices 14′, 18′ have their own spacers, which are, e.g., differently dimensioned or differently arranged than the spacers 26′.

In the exemplary embodiments explained with reference to FIGS. 1 to 4, the movement devices 12(′) and 14(′) are used as holders and counterholders. However, the present disclosure is not limited to this example. In general, the technique disclosed herein can be applied to any linear electric drive conveyor having different types of movement devices. The technique can even be used on linear electric drive conveyors that are only supposed to use one type of movement device to identify incorrectly installed movement devices of the wrong type.

In the exemplary embodiments explained with reference to FIGS. 1 to 4, the different external geometries of the first and second movement devices 12(′)-18(′) are brought about by different or differently aligned tools 22(′), 24(′) and by spacers 26′. However, the present disclosure is not limited to these examples. For example, different external geometries can also be caused by differently dimensioned movement devices. It is also possible that the first and second movement devices differ from one another in some way in their outer contours directed in a direction of movement (e.g., on their end faces).

In the exemplary embodiments explained with reference to FIGS. 1 to 4, the conveyors 10(′) each comprise only two different types of movement devices, namely the first movement devices 12(′), 16(′) and the second movement devices 14(′), 18(′). However, the present disclosure is not limited to these examples. For example, further movement devices, e.g., third movement devices, could be comprised, the external geometries of which differ from the movement devices 12(′)-18(′). For example, a transport item could be transported by the interaction of a first movement device, a second movement device and a third movement device. The third movement devices may also be identified according to the technique disclosed herein.

The invention is not limited to the preferred exemplary embodiments described above. Rather, a plurality of variants and modifications are possible which likewise make use of the inventive concept and therefore fall within the scope of protection. In particular, the invention also claims protection for the subject matter and the features of the dependent claims, irrespective of the claims to which they refer. In particular, the individual features of independent claim 1 are each disclosed independently of one another. In addition, the features of the subclaims are also disclosed independently of all the features of independent claim 1. All ranges specified herein are to be understood as disclosed in such a way that all values falling within the respective range are individually disclosed, e.g., also as the respective preferred narrower outer limits of the respective range.

### LIST OF REFERENCE SIGNS

10(′) linear electric drive conveyor
11(′) control unit
12(′) first movement device
14(′) second movement device
16(′) first movement device
18(′) second movement device
20(′) transport item
22(′) first tool
24(′) second tool
26(′) spacer
P1(′)-P4(′) positions

1. A method of operating, preferably initializing, a linear electric drive conveyor having a plurality of movement devices which are electromagnetically and independently movable, wherein the plurality of movement devices has at least one first movement device having a first external geometry and at least one second movement device having a second external geometry which is different from the first external geometry, the method comprising
lining up the plurality of movement devices so that the lined up plurality of movement devices touch one another;
determining positions of the lined up plural movement devices; and
identifying at least one of the at least one first movement device and the at least one second movement device in the lined up plurality of movement devices based on the determined positions.

2. The method according to claim 1, wherein:
the identifying is further based on at least one of at least one predetermined geometry information relating to the first external geometry and the second external geometry and a difference between the first external geometry and the second external geometry.

3. The method according to claim 1, further having:
determining at least one distance between the determined positions,
wherein the identifying is further based on the determined at least one distance.

4. The method according to claim 1, wherein
the at least one first movement device and the at least one second movement device differ from one another in their outer contours directed in a direction of movement; and
the plurality of movement devices are lined up in the direction of movement.

5. The method according to claim 1, wherein:
the at least one first movement device has a first tool; and
the at least one second movement device has no tool or a second tool, wherein the first tool and the second tool are at least one of differently oriented, differently formed and/or differently arranged.

6. The method according to claim 1, wherein:
the at least one first movement device has a holder; and
the at least one second movement device has a counterholder.

7. The method according to claim 1, wherein:
the at least one first movement device has a spacer; and
the at least one second movement device has no spacer or has a further spacer, wherein the spacer and the further spacer are at least one of differently aligned, differently dimensioned and/or differently arranged.

8. The method according to claim 1, wherein at least one of:
the positions are determined via a sensor system of the linear electric drive conveyor; and
the positions are determined by detecting electromagnetic induction in at least one coil of the linear electric drive conveyor caused by the plurality of movement devices.

9. The method according to claim 1, wherein at least one of the following features is fulfilled:
the plurality of movement devices are lined up at a speed that is less than a normal operating speed of the plurality of movement devices;
the plurality of movement devices are lined up with a force control;
the plurality of movement devices are lined up via an adapted controller parameterization so that, in the event of contact, a maximum force is within a predetermined range; and
the multiple movement devices are braked immediately before they touch one another.

10. The method according to claim 1, wherein:
the identifying takes place at least one of without external sensors and is purely software-based.

11. The method according to claim 1, wherein:
one of the at least one first movement device and one of the at least one second movement device are each designed for jointly transporting a transport item that is clamped or held between the one of the at least one first movement device and the one of the at least one second movement device.

12. The method according to claim 1, wherein
the at least one first movement device has a plurality of first movement devices;
the at least one second movement device has a plurality of second movement devices; and
the plurality of first movement devices and the plurality of second movement devices are arranged alternately one after the other.

13. The method according to claim 1, further having at least one of:
operating the linear electric drive conveyor in a normal operating mode in response to the identifying; and
outputting an error message if at least one of the identified at least one first movement device and the identified at least one second movement device is arranged in an order that deviates from a desired order.

14. The method according to claim 1, wherein:
the linear electric drive conveyor is a long-stator linear drive conveyor, a short-stator linear drive conveyor or a planar linear drive conveyor.

15. A Linear electric drive conveyor comprising:
a plurality of movement devices which are electromagnetically and independently movable, wherein the plurality of movement devices has at least one first movement device having a first external geometry and at least one second movement device having a second external geometry different from the first external geometry; and
a control unit configured to carry out a method according to claim 1.

16. The method according to claim 1, wherein:
the method of operating the linear electric drive conveyor is a method of initializing the linear electric drive conveyor; and
one of the at least one first movement device and one of the at least one second movement device are each designed for jointly transporting a container that is clamped or held between the one of the at least one first movement device and the one of the at least one second movement device.

17. The method according to claim 1, wherein:
the at least one first movement device has a container holder; and
the at least one second movement device has a container counterholder.

18. The method according to claim 1, wherein the positions are determined via an internal sensor system of the linear electric drive conveyor, the internal sensor system having a plurality of position sensors.

19. The method according to claim 1, wherein at least one of the following features is fulfilled:
the plurality of movement devices are lined up at a speed of at least ≤0.5 m/s, which is less than a normal operating speed of the plurality of movement devices;
the plurality of movement devices are lined up with a force control that limits a maximum thrust force with which the plurality of movement devices push against one another; and
the plurality of movement devices are lined up via an adapted controller parameterization so that, in the event of contact, a maximum force is within a predetermined range and an increase in a motor temperature is reduced.

20. The method according to claim 1, further comprising operating the linear electric drive conveyor in a normal operating mode for transporting transported goods, in response to the identifying.
